(19) United States
(12) Patent Application Publication
(10) Pub. No.: US 2020/0203085 A1
(43) Pub. Date: Jun. 25, 2020

(54) Double Hybridized Ion Capacitor with High Surface Area Carbon Electrodes

(71) Applicant: Sparkle Power LLC, Rochester, NY (US)

(72) Inventors: Huanlei Wang, Edmonton (CA); David Mitlin, Lakeway, TX (US)

(21) Appl. No.: 16/723,495

(22) Filed: Dec. 20, 2019

Related U.S. Application Data
(60) Provisional application No. 62/782,703, filed on Dec. 20, 2018.

(51) Int. Cl. H01G 11/06; H01G 11/50; H01G 11/34; H01G 11/26; H01M 10/0525; H01G 9/04; H01G 9/022

(52) U.S. Cl. CPC H01G 11/06; H01G 11/50; H01G 11/34; H01G 9/038; H01M 10/0525; H01G 9/058; H01G 11/26

(57) ABSTRACT

A double hybridized ion capacitor including a positive electrode and a negative electrode. Each of the positive electrode and negative electrode includes high surface area carbon. In one embodiment, the high surface area carbon is derived from gulfweed. The double hybridized ion capacitor delivers 127 W h kg⁻¹ at 332 W kg⁻¹ and 40 W h kg⁻¹ at 33,573 W kg⁻¹.

### CROSS-REFERENCE TO RELATED APPLICATIONS

The instant application claims priority to co-pending U.S. Provisional Application No. 62/782,703, filed on Dec. 20, 2018, and entitled “Double Hybridized Ion Capacitor (DHIC) with Sulfurized Carbon Electrodes Yields 6 Seconds Charging and 100,000 Cycles Stability with 1% Capacity Fade”. The entirety of the aforementioned provisional application is incorporated by reference in its entirety.

### FIELD OF THE INVENTION

The invention is generally concerned with energy storage devices, and in particular energy storage devices with a high surface area carbon electrode. In one aspect, the invention is directed to double hybridized ion capacitors (DHICs) and, more particularly, the invention is concerned with DHICs that achieve a combination of extreme supercapacitor-like cyclability with hybrid ion capacitor energy and power.

### BACKGROUND

There is an increasing demand for energy storage devices with both high energy and high power characteristics. Currently, lithium ion batteries (LIBs) and supercapacitors are the two dominant energy storage systems, with LIBs having by far the widest market penetration. Supercapacitors (also known as and referred to as “ultracapacitors” or “electrochemical capacitors”) are used in fast rate applications, possessing a high power density of 5-10 kW kg⁻¹ and long cycle life. However, supercapacitors possess rather a low energy density of 4-6 W h kg⁻¹.

LIBs possess high energy density or around 150 W h kg⁻¹ but suffer from a low power density, typically below 1000 W kg⁻¹. LIBs can only cycle several thousand times before failure.

Hybrid ion capacitors (HICs) based on lithium ion capacitors (LICs) or sodium ion capacitors (NICs) are a key emerging approach to boost the energy of an ultracapacitor. HICs may operate in standard ion battery-type carbonate-based electrolytes. This expands the device voltage window from 2.7 V for acetonitrile-based electrolytes employed in commercial supercapacitors, to 3.5 V or higher employed in LIBs. Since the energy of a capacitor scales with its voltage squared, a major energy boost results. Moreover, unlike commercial supercapacitors that store charge only by electrical double layer capacitance (EDLC), HIC electrodes store charge by additional mechanisms such as reversible ion adsorption at defects and heteroatoms, possibly by ion intercalation (negative electrode), Li atom underpotential deposition (negative electrode) and redox reactions (positive and negative electrode). This boosts the specific capacitance of the electrodes and of the device, i.e. the “C” in the Energy=½ CV² formula.

HICs commonly consist of capacitor-type cathode and battery-type anode, wherein charge is stored by ion insertion into the bulk of the anode, and by reversible ion adsorption at the surface of the cathode. Activated carbons are commonly used as typical capacitor-type cathodes, with many novel carbons (including graphene, carbon nanotubes, and porous amorphous carbon) being reported as well. Graphite, metal oxides, and intercalation compounds are employed as the battery-type anode. From a low cost perspective, carbons derived from biomass are one of the most promising candidates for electrodes on either side of the device. Ideal carbons are not only inexpensive, but also possess an advantageous combination of large surface area and controlled pore size distribution, along with rich heteroatom content for reversible ion adsorption. Such characteristics may provide fast ion transport through the pores and provide abundant electrochemically active sites through a range of voltages.

HIC anodes typically operate by reversible ion insertion into the bulk of a non-graphitic or graphitic carbon. This indicates that charge storage becomes dependent on bulk solid-state Li diffusivity. At room temperature, bulk solid-state diffusion of Li is intrinsically slower than ion transfer through the liquid filled pores of the large surface area cathode. Hence the anode becomes power mismatched to the cathode, where at fast charging rates the electrode capacities are imbalanced. Akin to conventional graphite LIB anodes, bulk storage carbon-based LIC anodes are also known to suffer from Li plating at the anode at high powers. Akin to conventional LIBs, LICs also suffer from ion insertion—induced damage at the anode, e.g. pulverization or exfoliation. Employing a titania-type anode significantly reduces the plating risk by shifting the anode voltage to about 1.5 V higher than the plating potential. However, this reduces the useful voltage window of the device and gives anode capacities that are in the 150 mA h g⁻¹ range, i.e. less than half those reported for graphite and far lower than for hard carbons. The high voltage of the titania anode also gives a low overall device voltage, i.e. the voltage of the cathode minus that of the anode. As a result, the device energy is substantially decreased. Importantly, employing a titania-type anodes leads to significant CO₂ generation during prolonged cycling or storage at charge due it its catalytic effect on electrolyte decomposition. This is an obvious and significant explosion—safety risk.

Commercial LICs have device energies of 13 Wh g⁻¹ or lower, e.g., LICs offered by JSR Micro Ultimo™. Hence it may be argued that LICs compete with supercapacitors in terms of their energy, not with LIBs that possess far higher energy. Since LICs rely on ion insertion rather than ion adsorption anodes, their safety characteristics and overall cyclability remain far below that of conventional supercapacitors. An ideal “next generation” LIC may be one that captures the essential low cost and high safety of a supercapacitor, while offering superior energy and comparable power and cyclability. Similar to a commercial device, the carbon source for the electrodes needs to be inexpensive, e.g., bio-material derived.

### SUMMARY OF THE INVENTION

Accordingly, it is an object of the present invention to provide a new and improved energy storage device having high safety i.e. intrinsic resistance to metal plating and to CO₂ generation, low cost, high power, high energy and high cyclability. In one embodiment, the present invention is a double hybridized ion capacitor including a supercapacitor and a hybrid ion capacitor. One aspect of the invention is directed to energy storage devices, and in particular, energy storage devices with high surface area carbon electrodes.

One embodiment of the disclosed invention is a double hybridized ion capacitor (DHIC) including: a high surface area carbon-containing positive electrode; and a high surface area carbon-containing negative electrode, wherein the high surface area carbon of the positive electrode is identical to the high surface area carbon of the negative electrode. In one embodiment, the high surface area carbon is a sulfurized carbon. In one embodiment, the negative electrode has a reversible capacity of 1186 mA h g⁻¹. In one embodiment, the sulfurized carbon is heteroatom doped. In one embodiment, the DHIC includes an absorption electrode, i.e., the DHIC does not include an ion insertion anode.

In a further embodiment, the double hybridized ion capacitor further includes an electrolyte. In one embodiment, the electrolyte comprises LiPF₆ salt and a solvent. In one embodiment, a separate source of Li is not provided.

In a further embodiment, the double hybridized ion capacitor further includes an electrolyte. In one embodiment, the electrolyte comprises NaPF₆ and a solvent. In one embodiment, a separate source of Na is not provided.

In a further embodiment, the double hybridized ion capacitor further includes an electrolyte. In one embodiment, the electrolyte comprises KPF₆ and a solvent. In one embodiment, a separate source of K is not provided.

In another embodiment, a precursor of the high surface area carbon is gulfweed. In one embodiment, a mass ratio of the positive electrode to the negative electrode is between 1:1 to 1:6, and in a particular embodiment, the mass ratio is 1:2. In one embodiment, the double hybridized ion capacitor delivers 127 W h kg⁻¹ at 332 W kg⁻¹. In one embodiment, the double hybridized ion capacitor delivers 40 W h kg⁻¹ at 33,573 W kg⁻¹. In one embodiment, the double hybridized ion capacitor has a 99% capacity retention ratio after 100,000 cycles at 0-3.5V.

A further embodiment is directed to a double hybridized ion capacitor including: a positive electrode; and a negative electrode, wherein the positive electrode includes high surface area carbon derived from gulfweed and the negative electrode includes high surface area carbon derived from gulfweed. In one embodiment, the double hybridized ion capacitor delivers 127 W h kg⁻¹ at 332 W kg⁻¹. In one embodiment, the double hybridized ion capacitor delivers 40 W h kg⁻¹ at 33,573 W kg⁻¹. In one embodiment, the double hybridized ion capacitor has 99% capacity retention ratio after 100,000 cycles at 0-3.5V.

A further embodiment is directed to a method for manufacturing a high surface area carbon, the method including: combining gulfweed with potassium hydroxide (KOH) and drying the combined gulfweed and KOH to form a precursor comprising gulfweed; and carbonizing the precursor at 900° C. to form a high surface area carbon, wherein the sponge like carbon comprises macropores, micropores and mesopores.

Another embodiment is directed to an electrode material comprising a high surface area carbon made according to the aforementioned method.

Another embodiment is directed to a carbon material derived from KOH-activated gulfweed, wherein the carbon material includes macropores, micropores and mesopores. In one embodiment, the carbon material.

In another embodiment, it is contemplated that the high surface area carbon is used with or without lithium or sodium cathode, iron phosphate (LFP, NFP) cathode, nickel cobalt aluminum (NCA) cathode, a nickel manganese cobalt (NMC) cathode, lithium or sodium cobalt oxide (LCO, NCO) cathode, Prussian blue analogs (PBAs), sodium vanadium phosphate and its alloyed modifications, vanadium fluorophosphate (NaVPO₄F) and its alloyed modifications, Na₂FeP₂O₇ and Na₂MnP₂O₇, sodium vanadium oxide and its alloyed modifications, pure and doped sodium manganese oxide, sodium magnesium manganese oxide, layered oxides (NaT_{M}O₂, T_{M}=Ti, V, Cr, Mn, Fe, Co, Ni, and a mixture of 2 or 3 elements), Na₂V₂O₅ and its alloyed modifications, iron-based mixed-polyanion compounds LiₓNa₄₋ₓFe₃(PO₄)₂(P₂O₇) (x=0-3), NaxMO₂ where M is one or a combination of several transition metals, NASICON structures, NaNbFe(PO₄)₃, Na₂TiFe(PO₄)₃ and Na₂TiCr(PO₄)₃, NaFe_{0:5}Mn_{0:5}PO₄, NaVPO₄F, Na₃V₂(PO₄)₂F₃, and Na_{1:5}VOPO₄F_{0:5}, Na₂FeP₂O₇, Na_{0.67}Ni_{0.3}-xCuₓMn_{0.7}O₂, layered sodium transition metal oxides (NaₓTMO₂), Na_{0.76}Mn_{0.5}Ni_{0.3}Fe_{0.1}Mg_{0.1}O₂, O3-type NaNi_{1/4}Na_{1/6}Mn_{2/12}Ti_{4/12}Sn_{1/12}O₂ oxide, or NaₐNi_{(1-x-y-z)}MnₓMg_{y}Ti_{z}O₂, Na₂MnFe(CN)_{6.}

It is contemplated that one or more of the aforementioned embodiments or features can be combined with one or more of the aforementioned embodiments or features. As such, the currently disclosed invention is not limited to the only the aforementioned embodiments or features.

These aspects and others are illustrated and described in the detailed description and attached figures.

### BRIEF DESCRIPTION OF THE DRAWINGS

FIG. 1 is a schematic illustration of a double hybridized ion capacitor (DHIC);

FIG. 2 is a schematic illustration of the preparation of a high surface area carbon, e.g., a Sponge Like Carbon (SLC), and the fabrication of a DHIC;

FIGS. 3(a)-3(f) illustrate x-ray diffraction patterns of the SLC and SLC-0 samples (FIG. 3(a)), Raman spectra of the SLC and SLC-0 samples (FIG. 3(b)), nitrogen adsorption-desorption isotherms (FIG. 3(c)), DFT obtained pore size distributions (FIG. 3(d)), high-resolution XPS N1s spectra of SLC (FIG. 3(e)), and high-resolution XPS O1s spectra of SLC (FIG. 3(f)).

FIGS. 4(a)-4(d) are SEM micrographs of SLC (FIG. 4(a)) and SLC-0 (FIG. 4(b)), TEM micrograph of SLC (FIG. 4(c)), and high-resolution TEM micrograph of SLC (FIG. 4(d)).

FIGS. 5(a)-5(f) illustrate the electrochemical performance of half-cells with FIG. 5(a) illustrating CV curves of SLC at a scan rate of 0.1 mVs⁻¹, FIG. 5(b) illustrating galvanostatic charge-discharge curves of SLC tested at 0.1 A g⁻¹, FIG. 5(c) illustrates rate capability at various current densities, FIG. 5(d) illustrates cycling performance and coulombic efficiency of SLC tested in 1 A g⁻¹, FIG. 5(e) illustrates galvanostatic charge-discharge curves of SLC at various densities between 3.0-4.5 V vs. Li/Li⁺, and FIG. 5(f) illustrates rate performance of SLC electrode at 3.0-4.5 V vs Li/Li⁺.

FIGS. 6(a)-6(f) illustrate the electrochemical performance of SLC//SLC DHIC devices with FIG. 6(a) illustrating CV curves with different anode to cathode mass ratios, tested at 10 mV s⁻¹, FIG. 6(b) illustrating galvanostatic charge-discharge curves with different anode to cathode mass ratios, tested at 10 A g⁻¹, FIG. 6(c) illustrating galvanostatic charge-discharge curves with an anode to cathode mass ratio of 1:2 at different current densities, FIG. 6(d) illustrating cycling stability of 1:2 ratio DHIC under 0-3.5 Vat a current density of 50 A g⁻¹, FIG. 6(e) illustrating Nyquist plots before and after cycling, and FIG. 6(f) illustrating Ragone plots of DHICs with different mass ratios.

FIGS. 7(a) and (b) illustrate the improved capacity retention and power and energy densities of the high surface area carbon disclosed herein.

### DETAILED DESCRIPTION

A double hybridized ion capacitor (DHIC) architecture that circumvents at least the problems mentioned above is described herein. The present invention relates to an energy storage device having high safety, high power and high energy, and in particular, a double hybridized ion capacitors having high safety, power and energy. The DHIC disclosed herein is safer than known devices i.e., intrinsically resistant to metal plating and to CO₂ generation. The DHIC disclosed herein is low cost, has high power, has high energy and has high cyclability as compared to known devices. In one embodiment, the DHIC hybridizes a conventional supercapacitor with a hybrid ion capacitor. This achieves the sought-after combination of extreme supercapacitor-like safety and cyclability but with hybrid ion capacitor energy and power. Compared to the presently disclosed DHIC, a conventional hybrid ion device (HIC) is less safe (e.g., a “less safe” device is more likely to malfunction, explode, catch fire, leak, burst, and/or rupture) and offers less power due to the ion insertion anode, while a supercapacitor would be of much lower energy. HIC devices offer substantially higher energy that EDLC supercapacitors; however, HIC devices fall short in safety, power and in lifetime. A system where a bulk insertion electrode is in series with a surface adsorption electrode, which is the standard HIC design, is inherently mismatched in cycling and rate capability: An anode undergoes large volume changes and requires up to microns in solid-state ion diffusion distances will always struggle to keep up with a cathode where ion storage occurs on the surface and diffusion in the electrolyte. The bulk ion insertion anode in a HIC leads to safety issues due to metal plating at high charging rates and after extended cycling. The bulk ion insertion anode in a HIC also leads to CO₂ generation after extended cycling or storage at charged state. These limitations are addressed and effectively overcome in view of the invention disclosed herein, wherein ion insertion is not used. The presently disclosed DHIC offers a surface ion adsorption electrode, which increases safety, power and cyclability.

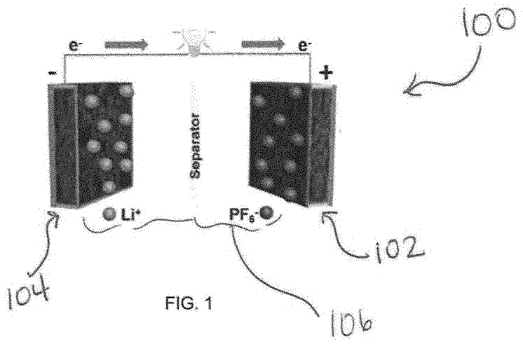

As shown in FIG. 1, a DHIC 100 includes a high surface area carbon-containing positive electrode (cathode) 102 and a high surface area carbon-containing negative electrode (anode) 104. In one embodiment, the negative electrode 104 has a reversible capacity of 1186 mA h g⁻¹. It is contemplated that the mass ratio of the positive electrode 102 to the negative electrode 104 is any mass ratio that is effective for the device and application of the DHIC 100. In one embodiment, the mass ratio of the positive electrode 102 to the negative electrode 104 is between 1:1 to 1:6. In a particular embodiment, the mass ratio is 1:2.

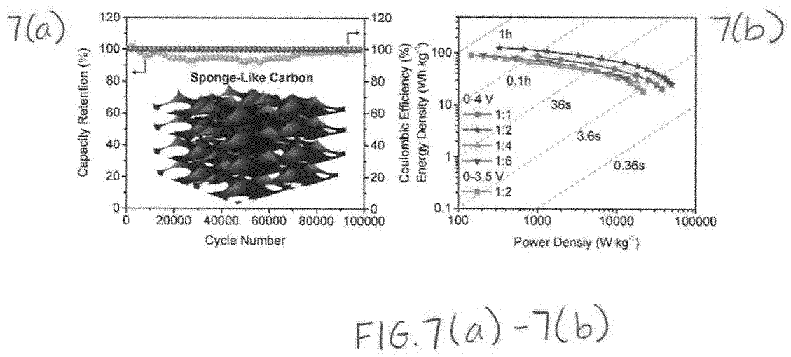

As noted above, the DHIC 100 disclosed herein has supercapacitor-like cyclability and safety but with hybrid ion capacitor energy and power. In one embodiment, and with reference to, e.g., FIGS. 7(a) and 7(b) as a specific example, the DHIC 100 delivers 127 W h kg⁻¹ at 332 W kg⁻¹. In another embodiment, the DHIC 100 delivers 40 W h kg⁻¹ at 33,573 W kg⁻¹ (based on total active material). In one embodiment, the DHIC 100 has a 99% capacity retention ratio after 100,000 cycles at 0-3.5V. Such extended cycling lifetime at deep charge—discharge has not been reported prior for any hybrid ion capacitor architecture.

Conventional HICs have a discharge voltage limit of about 1.5 V, which attempts to reduce the metal plating danger on the anode at lower voltages. Because of its greater safety, the DHIC can be discharged all the way to 0 V, reducing the cost of additional control electronics and increasing the overall device capacity.

It is contemplated that in one embodiment of the DHIC 100, the high surface area carbon of the positive electrode 102 is identical to the high surface area carbon of the negative electrode 104. A “high surface area carbon” as used herein encompasses carbon-containing material that provide a large amount of surface area with a variety of pore distribution, e.g., macropores, micropores, mesopores, and combinations thereof, which facilitates reversible ion adsorption, fast ion transport, and abundant electrochemically active sites through a range of voltages. In one embodiment, the high surface area carbon is heteroatom (S, N, O) doped. The high surface area carbon possesses chemistry, structure, porosity and pore size distribution necessary for facile ion transfer kinetics.

In one embodiment, the high surface area carbon is a sulfurized carbon. Sulfurized carbon is a compound in which short sulfur chains are covalently bonded onto the surface of carbon, i.e., onto carbon particles. Sulfurized carbon can be manufactured in the laboratory by known processes. In one embodiment, the sulfurized carbon is heteroatom (N,O) doped.

In another embodiment, it is contemplated that the high surface area carbon is used as a free standing electrode. In another embodiment, the high surface area carbon is employed as an ancillary phase in an electrode, in parallel with a primary material, such as graphite.

In one embodiment of the DHIC, the at least one electrode is a positive electrode, the positive electrode further comprising additional carbon material. In one embodiment of the DHIC, the at least one electrode is a positive electrode, the positive electrode includes high surface area carbon with or without a lithium or sodium cathode, iron phosphate (LFP, NFP) cathode, nickel cobalt aluminum (NCA) cathode, a nickel manganese cobalt (NMC) cathode, lithium or sodium cobalt oxide (LCO, NCO) cathode, Prussian blue analogs (PBAs), sodium vanadium phosphate and its alloyed modifications, vanadium fluorophosphate (NaVPO₄F) and its alloyed modifications, Na₂FeP₂O₇ and Na₂MnP₂O₇, sodium vanadium oxide and its alloyed modifications, pure and doped sodium manganese oxide, sodium magnesium manganese oxide, layered oxides (NaT_{M}O₂, T_{M}=Ti, V, Cr, Mn, Fe, Co, Ni, and a mixture of 2 or 3 elements), Na₂V₂O₅ and its alloyed modifications, iron-based mixed-polyanion compounds LiₓNa₄₋ₓFe₃(PO₄)₂(P₂O₇) (x=0-3), NaxMO₂ where M is one or a combination of several transition metals, NASICON structures, NaNbFe(PO₄)₃, Na₂TiFe(PO₄)₃ and Na₂TiCr(PO₄)₃, NaFe_{0.5}Mn_{0.5}PO₄, NaVPO₄F, Na₃V₂(PO₄)₂F₃, and Na_{1:5}VOPO₄F_{0:5}, Na₂FeP₂O₇, Na_{0.67}Ni_{0.3}-xCuₓMn_{0.7}O₂, layered sodium transition metal oxides (NaₓTMO₂), Na_{0.76}Mn_{0.5}Ni_{0.3}Fe_{0.1}Mg_{0.1}O₂, O3-type NaN_{1/4}Na_{1/6}Mn_{2/12} Ti_{4/12} Sn_{1/12}O₂ oxide, NaₐNi_{(1-x-y-z)}MnₓMg_{y}Ti_{z}O₂, Na₂MnFe(CN)_{6.}

It is contemplated that that a variety of known precursors can be utilized to obtain the high surface area carbon for the positive and negative electrodes 102, 104 for the DHIC 100. In one embodiment, the precursor of the carbon is a marine biomass, Sargassum (referred to herein as “gulfweed”). Other precursors may be utilized to form the high surface area carbon and/or sulfurized carbon used in the disclosed DHIC, including, but not limited to hemp, flax, jute, ramie, nettle, kenaf, cannabis, lignin, starch, crude fiber, ash, sugar, and pectin. Combinations of precursors are contemplated.

In a particular embodiment, the carbon precursor employed in the high surface area carbon is gulfweed. Gulfweed is widely distributed in the Yellow Sea and the East China Sea. During the Spring, large gulfweed blooms can be detrimental to the environment, affecting marine ecosystems, fisheries, reaching beaches and clogging waterways. Harvesting such a “pest” species during its bloom represents an economically promising pathway for improving water quality. In a particular embodiment of the present invention, gulfweed is employed as a precursor to create high surface area carbons that are “sponge-like” carbons (SLC). Such sponge-like carbons have chemical and textural characteristics ideally suited for fast and reversible Li storage through a range of voltages. The inventors have surprisingly found gulfweed-derived carbon to be beneficial for hybrid ion capacitor (HIC) and/or battery applications, which was not previously known or contemplated.

It is contemplated that the gulfweed can be used directly after harvesting, i.e., the gulfweed does not need to be processed or refined prior to utilization as a precursor of the high surface area carbon used in the DHIC disclosed herein. However, the invention is not limited in this regard as the gulfweed can be processed prior to its use, e.g., undergo a washing step, or other steps that may optimize the usage of such biomass as a precursor.

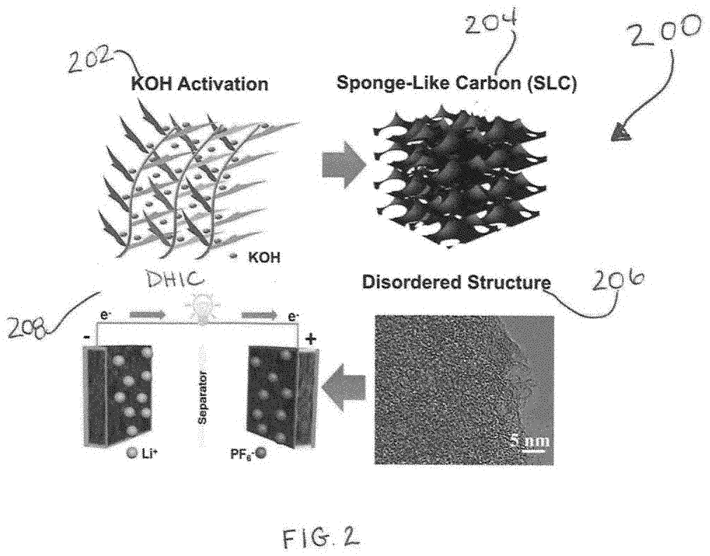

Manufacturing high surface area carbon includes combining the precursor material with potassium hydroxide (KOH), drying the combination, and forming a precursor that is subsequently carbonized at 900° C. to form a high surface area carbon. The inventors of the present invention have surprising found that using gulfweed as a precursor forms an advantageous high surface area carbon that is “sponge-like” (a so-called “sponge-like carbon”) that includes macropores, micropores and mesopores of 1:1000 to 1000:1 volume ratio of each. Such method is shown in FIG. 2, which provides a method 200, wherein in step 202, the gulfweed is activated with KOH to form a SLC 204, which is a structure 206 that is used 208 in the DHIC as positive and negative electrodes. It is contemplated that high surface area carbon disclosed herein can be used in an electrode material for, e.g., energy storage devices such as batteries, capacitors, super capacitors, half-cells, and the like. It is contemplated that the high surface area carbon may serve as standalone materials or may be used as a support or host for other active or inactive materials in either the positive electrode or the negative electrode.

Referring back to FIG. 1, the DHIC 100 further includes an electrolyte 106. The electrolyte used in the DHIC 100 can be any known electrolyte. In one embodiment, the electrolyte 106 comprises a solvent and LiPF₆ or NaPF₆. In one embodiment, a separate source of Li is not provided, thereby reducing the danger of large-scale Li plating and dendrite growth. The absence of a separate source of Li ions improves the design value of the presently disclosed DHIC 100, as “extra” Li introduced via chemical or electrochemical pre-lithiation may become a safety concern due to its propensity to plate as macroscopic particles/dendrites on the anode during fast-rate cycling.

DHICs can run based on aqueous as well as non-aqueous electrolytes. most commercial devices operate using a salt dissolved in an organic electrolyte that is designed to minimize parasitic side reactions at high voltages The solvents employed include various combinations of ethylene carbonate, dimethyl carbonate, diethyl carbonate, propylene carbonate etc. Electrolyte additives can be used which can beneficially affect the performance of HICs, including, for example, fluoroethylene carbonate (FEC), or vinylene carbonate (VC), or lithium nitrate (LiNO₃).

A particular embodiment of the DHIC 100 includes a positive electrode 102, a negative electrode 104, and an electrolyte 106, wherein the positive electrode 102 includes high surface area carbon derived from gulfweed and the negative electrode 104 includes high surface area carbon derived from gulfweed. The electrolyte 106 comprises LiPF₆ and the DHIC 100 does not include a separate source of Li.

The presently disclosed DHIC 100 has architecture based on identical optimized high surface area carbons and is shown to be highly effective in providing extended cycling lifetime and fast charging, while still maintaining promising energy characteristics. The presently disclosed DHIC device operates at a comparable voltage window as compared to “standard” asymmetric HICs, i.e. 3.5 V window (roughly symmetric voltage swing), which avoids deleterious electrolyte decomposition and associated capacity fade. In the presently disclosed DHIC device, electrolyte decomposition suppression is achieved by not having catalytic materials such as metallic Li or other metals in either electrode. Cycling capacity fade associated with extensive solid electrolyte interphase (SEI) formation does not occur until the DHIC device is tested at a 4.2 V window. The architecture of the presently disclosed DHIC device yields good energy values, while allowing for extremely fast charge and unparalleled cyclability, nearly on-par with classic EDLC devices.

These and other aspects of the invention are discussed in the following Examples.

### EXAMPLES

Synthesis of a High Surface Area Carbon Derived from Gulfweed

Material synthesis. Gulfweed and potassium hydroxide (KOH) with a mass ratio of 2:1 were added to 50 mL of distilled water. Then the mixture was dried in oven at 80° C. for 24 h to get the gulfweed/KOH precursor. The precursor was carbonized and activated at 900° C. with a heating rate of 3° C. min⁻¹ for 1 hour. Finally, the carbons were washed with 2 M HCl and deionized water, filtered, and dried. The resultant Sponge Like Carbon was labeled “SLC”.

For comparison, gulfweed was also directly carbonized at 900° C. without an activating agent, such as, for example, KOH, which is designated as “SLC-0”.

Material characterization. Scanning electron microscopy (SEM, Hitachi-54800) and transmission electron microscopy (JEOL, JEM-2010) analysis were carried out to investigate the morphology and structure of SLC and SLC-0 carbons. The degree of graphitization of the samples was characterized by X-ray diffractometer (XRD, Bruker D8 Advance, Cu-Kα radiation, 2θ=10°-80°) and Raman spectroscopy (Laser Confocal Micro-Raman Spectroscopy). The chemical composition of the samples was evaluated by X-ray photoelectron spectroscopy (XPS, Thermo ESCALAB 250 XI). The specific surface area and pore size distribution of the samples were characterized by nitrogen adsorption-desorption isotherms at 77 K with Micromeritics 3 Flex™ surface characterization analyzer. The related information of Brunauer-Emmett-Teller (BET) and Density Functional Theory (DFT) calculations is provided in the supporting information.

Electrochemical evaluation. All the electrochemical measurements were evaluated using CR2032 coin-type cells. For preparing working electrodes, 75 wt % active material, 15 wt % Super P and 10 wt % polyvinylidence fluoride were mixed with N-methyl-2-pyrrolidone, coated on stainless steel spacers, and then dried at 100° C. in vacuum oven. For devices, the anode to cathode mass ratio ranged from 1:1 to 1:6. In a half-cell, the mass loading for SLC is about 1 mg cm⁻². In LICs, the mass loading of SLC varies from 1 mg cm⁻² to 6 mg cm⁻², while the area of the cathode and the anode remained the same.

The electrode preparation procedure and mass loading is fairly standard in the field for HIC and LIB carbon testing. The thickness of electrode material was 50-60 μm.

Galvanostatic charge-discharge tests were tested using a Land CT2001A battery system. Cyclic voltammetry (CV) and electrochemical impedance spectroscopy (EIS) were carried out on a Gamry Interface 5000 workstation. For half-cells, the CR2032 coin cells were assembled inside an Ar-filled glove box by using polyethene as the separator, 1M LiPF₆ (solution with a 1:1 v/v mixture of ethylene carbonate/dimethyl carbonate EC/DMC) as the electrolyte, and lithium metal as the counter and reference electrode.

For lithium ion capacitor (LIC) devices, the coin cells were fabricated with cathodes and pre-activated anodes from identical SLC material. The pre-activated process consisted of 3 charge—discharge cycles at 0.01-3 V vs. Li/Li⁺, prior to being disassembled and incorporated into a full cell. The terminal 3 V vs. Li/Li⁺ ensured that the electrodes were in the fully delithiated state, which was a core aspect of the strategy for minimizing electrolyte decomposition in a full cell. The device CV experiments were performed at the scan rate from10 mV s⁻¹ to 200 mV s⁻¹. The device galvanostatic charge-discharge current densities were between 0.5 to 100 A g⁻¹, based on the mass of anode.

The gravimetric energy (E_{g}) and gravimetric power (P_{g}) of LICs are calculated according to the following equations:

P_{g}=I×ΔV/m (1)

E_{g}=P×t/3600 (2)

ΔV=(Vₘₐₓ−Vₘᵢₙ)/2 (3)

where I is the discharge current (A), m is the mass of the total active material on both electrodes (kg), t is the discharge time (h), Vₘₐₓ is the potential at the beginning of discharge after the IR drop, and Vₘᵢₙ is the potential at the end of discharge.

The volumetric power (Pᵥ) and volumetric energy (Eᵥ) of LICs can be calculated according to the following equations:

Pᵥ=ρ×P_{g} (4)

Eᵥ=ρ×E_{g} (5)

where ρ is the packing density of active materials (kg L⁻¹).

### Synthesis, Structure and Chemistry

FIG. 2 illustrates the steps involved in creating the DHIC devices, starting with the gulfweed precursor (shown washed up on a resort beach during bloom), and finishing with the complete coin cell. Different from traditional activation based on first carbonizing followed by activating, the method in the present invention combines pyrolysis with KOH activation in a single step. This creates an obvious process advantage since the high temperature portion of the synthesis route is performed one-pass versus the tradition two-pass. At high temperature the precursor is pyrolyzed while simultaneously reacting with the activating agent. The overall reaction between C and KOH is 6KOH+2C↔2K+3H₂+2K₂CO₃ above 400° C., followed by further decomposition of K₂CO₃ into K/K₂O/K₂CO₃/CO₂.

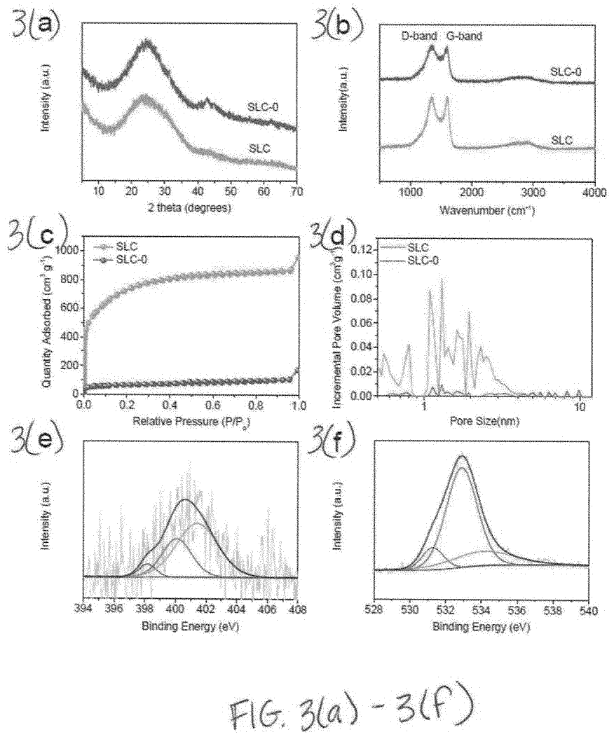

As shown in FIG. 3(a), the XRD patterns of SLC and SLC-0 samples have two broadened diffraction peaks, which may be indexed as the (002) and (100) reflections of the aligned defective graphene domains in the amorphous carbon. The average graphitic interlayer spacing of SLC and SLC-0 samples can be calculated from the center of the (002) peak, yielding a value of 0.35-0.36 nm, which is 4.5-7.5% dilated relative to the equilibrium spacing of graphite (0.335 nm). According to the well-known Scherrer equation, the thickness of graphitic domains (L_{c}) is calculated by using the full width at half-maximum of the (002) diffraction peak. The value of L_{c} is in the range of 0.62-0.66 nm, indicating the resultant carbons are composed of 1-2 layers of defective graphene (i.e. 0.62/0.36=1.72) in an amorphous matrix. Although the relatively larger graphitic layer spacing of SLC may be favorable for Li ion diffusion, the low number of graphene layers in each domain combined with their disorder will likely prevent significant intercalation. As has been demonstrated, non-graphitic hard carbons with low order will not appreciably intercalate Li even at low rates.

The structure of SLC and SLC-0 samples was further investigated by Raman analysis (FIG. 3b). There are two main peaks centered at about 1350 cm⁻¹ and 1600 cm⁻¹, corresponding to the disordered D-band and the graphitized G-band. The deconvolution of these two overlapping bands gives rise to two additional peaks at about 1160 cm⁻¹ (T-band) and at about 1500 cm⁻¹ (D″-band), which is usually observed in disordered carbons. The value of integrated intensity ratio (I_{G}/I_{D}) can be used to quantify the concentration of defects along with the graphitic layers. The ultimate degree of graphitic ordering results from the balance from carbonization-induced ordering and activation-induced disordering. The integrated intensity (I_{G}/I_{D}) of SLC is 0.32 (Table 1). This value indicates a highly disordered carbon, much closer in internal structure to conventional activated carbon versus partially ordered “pseudographitic” materials with I_{G}/I_{D} closer to 1. Rather than Li intercalation, the low voltage charge storage mechanism in these materials will be reversible Li atom underpotential deposition into nanopores, reversible Li adsorption at heteroatom functional groups, and at graphene defects such as divancies and Stone-Wales. The electrical conductivity is 125 and 40 S m⁻¹ for SLC and SLC-0 (Table 1), which is higher than that for some commercial activated carbons (Norit, 33 S m⁻¹). This may be attributed to N-doping that is known give improved bulk electrical conductivity.

Analysis of the nitrogen adsorption-desorption curves (FIG. 3c), gives the textural parameters of SLC and SLC-0 samples. The SLC sample possesses type I/IV isotherms, indicating a hierarchically porous structure. The amount of nitrogen adsorbed at the relatively low pressure (P/Pₒ<0.01) indicates the existence of abundant micropores, while the broadening of the knee at the relative pressure below 0.4 indicates the presence of mesopores. The textural parameters derived from the isotherms are shown in Table 1. As expected, SLC-0 (no KOH activation) is a low surface area carbon material. This will become important when discussing the differences in the Li storage characteristics; without nanopores, the reversible capacity is much lower for both the anode and the cathode. This is true even at the slowest charging—discharging rates. Per the BET method, the specific surface area of SLC is 2651 m² g⁻¹, versus 237 m² g⁻¹ for SLC-0. These numbers are in the same range as calculated by DFT, being 2369 and 211 m² g⁻¹, respectably. The total pore volume for SLC is 1.34 cm³ g⁻¹. This is far above the SLC-0, which is at 0.24 cm³ g⁻¹.

The pore size distributions of SLC and SLC-0 samples are displayed in FIG. 3d. As may be observed from the Table, the SLC sample is also highly mesoporous, containing 34% mesopores. The mesopores will provide interconnected pathways for efficient Li ion diffusion through the electrolyte filled pores, necessary for fast charging. The large specific surface area combined with heteroatom content are expected to increase the number of interfacial Li adsorption sites contributing to capacity via reversible surface adsorption. Both micropores and mesopores are expected to store charge at low voltages by Li atom underpotential deposition.

TABLE 1
Physical properties of SLC and SLC-0 samples.

| | | | | | | | | | | | | XPS | |
|---|---|---|---|---|---|---|---|---|---|---|---|---|---|
| | | | | | | | | | | | | composition | |
| | S_{BET}^{a} | S_{DFT}^{b} | Vₜ^{c} | ρ^{d} | pore vol (%)^{e} | | | d₀₀₂ | L_{c} | Conductivity^{f} | | (at %) | |
| Sample | (m²g⁻¹) | (m²g⁻¹) | (cm³g⁻¹) | (gcm⁻³) | V_{<1} ₙₘ | V_{1-2 nm} | V_{>2 nm} | (nm) | (nm) | (S m⁻¹) | I_{G}/ I_{D} | C | N/S/O |
| SLC | 2651 | 2369 | 1.34 | 0.58 | 19 | 47 | 34 | 0.36 | 0.62 | 125 | 0.32 | 78 | 22 |
| SLC-0 | 237 | 211 | 0.24 | 0.94 | 13 | 19 | 68 | 0.35 | 0.66 | 40 | 0.24 | 72 | 28 |

^{a}Specific surface area was calculated by Brunauer-Emmett-Teller (BET) method.
^{b}Specific surface area was calculated by density functional theory (DFT) method.
^{c}The total pore volume was determined by DFT method.
^{d}ρ represents the packing density. The packing density was assessed by pressing a certain amount of carbon material into a thin film under a pressure of 10 MPa.
^{e}The volume proportions of pores smaller than 1 nm (V < 1 nm), pores between 1 and 2 nm (V 1-2 nm), and pores larger than 2 nm (V > 2 nm) were also obtained by DFT analysis.
^{f}The conductivity was evaluated by the four-point probing method.

From the XPS analysis, we can obtain the near surface chemical composition of SLC and SLC-0 samples. Only carbon (C), sulfur (S), nitrogen, and oxygen are detected in non-trace quantities. Table 2 shows the relative surface concentrations (%) of nitrogen and oxygen moieties obtained by fitting the N1s and O1s core level XPS spectra. The fits of C 1s, N 1s, and O 1s spectra are shown in FIG. 1e-f. The C 1s region can be deconvoluted into four peaks of C=C/C—C (284.6 eV), C—O/C═N (285-286 eV), C═O/C—N (286-287 eV) and COOH (289-291 eV), respectively. For nitrogen, three peaks located at around 398, 400, and 401-402 eV are observed (FIG. 1e corresponding to pyridinic nitrogen (N-6), pyrrolic nitrogen (N-5) and quaternary nitrogen (N-Q). The pyrrolic nitrogen and quaternary nitrogen are considered to be the major functional groups for Li adsorption capacity. The nitrogen element in the SLC and SLC-0 samples is derived from the protein in the precursor, which can favor the formation of pyrrolic nitrogen functional groups. Moreover, the nitrogen content is 4 at % for SLC-0 and 1 at % for SLC. According to the O1s spectra (FIG. 1f), peaks centered at 531 eV, 532-533 eV and 535-536 eV, which are designated to C═O (O-I), C—OH and/or C—O—C (O-II), and COOH carboxylic groups (O-III). After activation, the portion of O-I decreased (Table 2). The introduction of nitrogen and oxygen atoms can provide both Li adsorption active functional groups and associated defects in the bulk and surface of a carbon, significantly increasing the overall reversible capacity. Depending on their binding energy with Li, these adsorption sites may be active through a range of voltages, including at high cathode potentials.

TABLE 2
Relative surface concentrations (%) of nitrogen and oxygen moieties
obtained by fitting the N1s and O1s core level XPS spectra.

| Sample | N-6 | N-5 | N-Q | O-I | O-II | O-III |
|---|---|---|---|---|---|---|
| SLC | 6.1 | 31.5 | 62.4 | 10.7 | 69.5 | 19.8 |
| SLC-0 | 11.3 | 50.9 | 37.8 | 32.0 | 63.0 | 5.0 |

### Morphology of the SLC and SLC-0 Samples

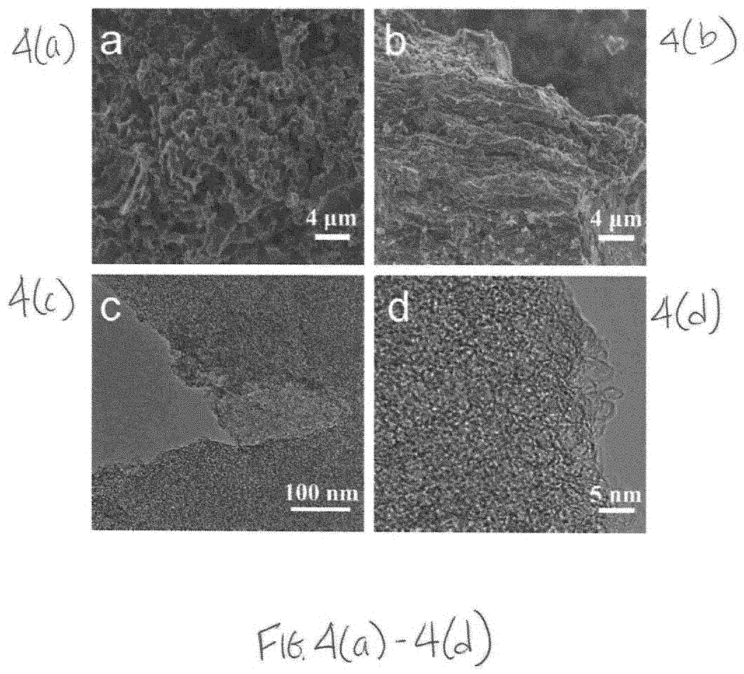

The morphology of the SLC and SLC-0 samples was investigated by scanning electron microscope. As highlighted by the SEM image (FIG. 4a), the SLC sample is sponge-like in morphology, offering macroscopic porosity in addition to the micro and mesopores. For comparison, macropores are not observed on the surface of the carbon prepared without activation (SLC-0) (FIG. 4b). The structure of SLC sample was analyzed by transmission electron microscopy (TEM) analysis. The TEM micrographs (FIG. 4c-d) demonstrate the relatively low degree of graphitic ordering, which is consistent with the XRD and Raman analysis. The observed contrast in the TEM micrographs is synonymous with carbons that are nanoporous.

### Electrochemical Performance of Half Cells

The electrochemical performance of SLC and SLC-0 samples was first analyzed versus Li/Li⁺. For showcasing device performance, it is customary to present half-cell data prior to presenting the full cell results. The half-cell data highlights the electrochemical behavior of a given material versus a well-defined reference electrode, i.e. Li/Li⁺. It is useful for understanding the anodic or cathodic ion storage mechanisms, which are always also understood in relation to the Li/Li⁺ reference. However, it is important to appreciate the major differences in the electrochemical conditions between full cell and half-cell analysis of the same materials, and that the two sets of data are not synonymous. In a half-cell, SLC is tested with a specific voltage excursion against a well-defined reference electrode, i.e. 0.01 V-3.0 V vs. Li/Li⁺. The thermodynamic conditions of the working electrode and the electrolyte are set and well-define. At these conditions, the SLC electrode will always become covered by a solid electrolyte interphase layer (SEI) since SEI begins to form below 1 V vs. Li/Li⁺. Especially for high surface area hard carbons, such as SLC, this irreversible capacity loss associated with SEI formation may be quite substantial. Cycle 1 Coulombic efficiency (CE) values as low as 30% are not unusual. Moreover, Li metal itself is known to be highly catalytic toward SEI formation, promoting extensive electrolyte decomposition on its surface.

In the SLC//SLC full cell, however, there is no solid Li or other metals in the electrodes (apart from the current collectors). The active Li ions originate from the 1 M of dissolved LiPF₆ salt. In a completely capacity balanced SLC//SLC cell, the voltage excursion of the anode and of the cathode are one-half of the total voltage window. Since the cell does not have a secondary reference electrode, the lowest voltage of the negative electrode is indeterminate vs. Li/Li⁺. This means that it is impossible to directly relate the voltage swing of the SLC negative electrode in a full cell to the voltage swing of a SLC working electrode in a half-cell. Practically, it means that the electrolyte decomposition in a full cell cannot be predicted from half-cell performance vs. Li/Li⁺: The SEI formation and CE loss in a half-cell is not synonymous SEI/CE in a full cell. Instead, in a full cell, electrolyte stability would have to be ascertained empirically by testing a device at different voltage windows and seeing at what point would there be significant capacity decay associated with extensive SEI and cathode electrolyte interphase (CEI) formation. Although conventional carbonate electrolytes are known to decompose to form SEI/CEI above roughly 4.2 V, the chemistry of the electrode surface is known to influence the actual value and decomposition rate. With carbons, significant electrolyte decomposition is known to occur above 4.5 V.^{59,65} In the device section of the manuscript, it will be demonstrated that some capacity decay can be observed at 4 V in the device, which may be associated with SEI/CEI formation on the electrodes. However, with a 3.5 V window, the electrolyte is fully stable and there is minimal capacity fade even after 100,000 cycles. Referring back to the half-cell data provided in this section, it is therefore important to appreciate that while there are high levels of SEI formation below 1 V vs. L/Li⁺, this does not mean that such degradation will occur in a full cell.

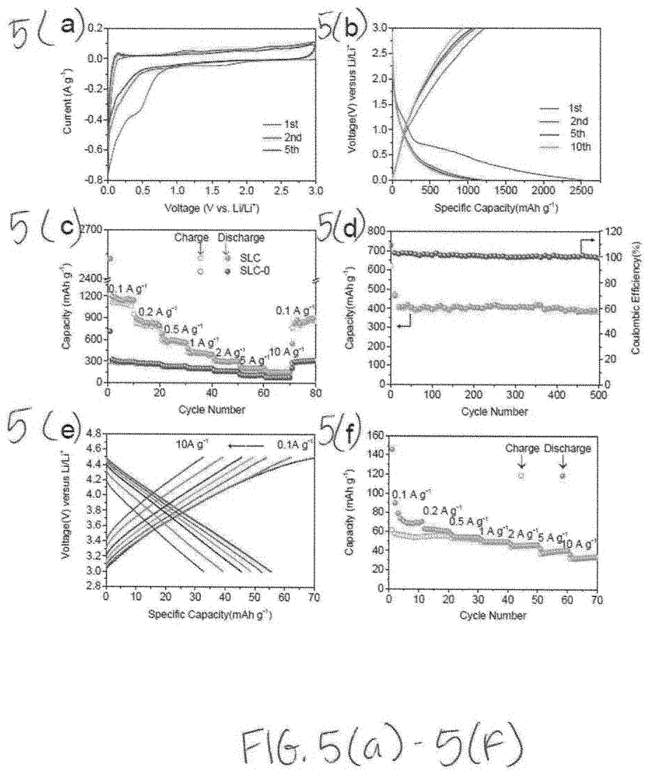

FIG. 5a shows the CV curves of SLC and SLC-0 samples, tested at 0.1 mV s⁻¹ through a voltage range of 0.01-3.0 V vs. Li/Li⁺. During the first lithiation there is a cathodic peak centered near 0.5 V, which then largely disappears by the second cycle. This is attributed to irreversible SEI formation, as well as the trapping of Li ions in the bulk carbon lattice. At cycle 2 and onward, the shape of the CV curves remains consistent, indicating a stable SEI and consistent charge storage mechanisms during cycling. During cycling, the CV curves of SLC show “box-like” behavior above 0.5 V vs. Li/Li⁺. This is ascribed to lithium reversibly binding with heteroatoms on the surface and in the bulk of SLC, as well as at edges and defect sites of graphene layers. However, no obvious “box-like” shape is observed for SLC-0, which may be ascribed to the lower specific surface area. Lithium atom underpotential deposition is expected to be a significant source of capacity at lower voltages, such as at 0.25 V vs. Li/Li⁺ and below.

FIG. 5b shows the galvanostatic charge—discharge profiles of SLC and SLC-0 samples, tested at a 0.1 A g⁻¹ between 0.01 V and 3.0 V vs. Li/Li⁺. The first cycle CE of SLC and SLC-0 is 48% and 42%, respectively. As mentioned, this relatively low CE is attributable to a combination of SEI formation on the carbon's large surface and irreversible trapping at defect sites, both occurring at below 1 V vs. Li/Li⁺. The reversible capacity of SLC is 1186 mA h g⁻¹, which is three times higher than the theoretical capacity of graphite and rivals the best 2D materials such as graphene. As shown in FIG. 5c, SLC displays excellent rate capability. Reversible capacities of 829, 590, 420, 294, 198, and 148 mA h g⁻¹ are obtained at current densities of 0.2, 0.5, 1, 2, 5, and 10 A g⁻¹. When the current rate is returned back to 0.1 A g⁻¹, the specific capacity is recovered to 911 mA h g⁻¹, indicating good reversibility and stability of the electrode structure. This result implies that SLC has a great potential as LIC anode.

FIG. 5d shows the cycling performance of SLC tested at 1 A g⁻¹. After 500 cycles, the SLC electrode can still maintain a discharge capacity of 388 mA h g⁻¹, with measured Coulombic efficiency at 100%. Electrochemical impedance spectra obtained before and after 500 cycles. In the high frequency range, R₁ represents the internal resistance of the cell, which is only slightly increased from 3.1Ω to 4.3Ω after 500 cycles. The R₂ appeared after 500 cycles, which is related to the resistance of lithium ion migration through the SEI film. In the medium frequency, the R_{ct} designated as the charge transfer resistance on the interface of electrode/electrolyte, and actually decreases from 16.1Ω to 14.9Ω after 500 cycles. Although the physical origin of this result is not fully clear, broadly it may be interpreted as cycling-induced activation of the carbon surfaces.

We also employed SLC as a cathode, tested between 3.0 and 4.5V at vs. Li/Li⁺ at various current densities (from 0.1 A g⁻¹ to 10 A g⁻¹). The capacity is mainly achieved by physisorption of PF6⁻. FIG. 5e shows the galvanostatic charge-discharge profiles of SLC, with the voltage versus capacity profiles being “capacitor-like”, i.e. nearly perfectly triangular. The capacity of SLC is 56 mA h g⁻¹, when tested at 0.1 A g⁻¹ after 10 cycles. This is substantially above that of conventional activated carbons, which are in the 30-37 mAh g⁻¹ range. The overall large adsorption surface area combined with surface heteroatoms is responsible for the favorable reversible capacity, allowing for numerous reversible Li ion adsorption sites. Per FIG. 5f, when the current density is increased to the very high value of 10 A g⁻¹, the capacity remains favorable at 33 mA h g⁻¹. Such fast charging may be ascribed to the hierarchical porous structure with ample mesoporosity, which allows for facile ion transport.

### Double Hybridized Ion Capacitor

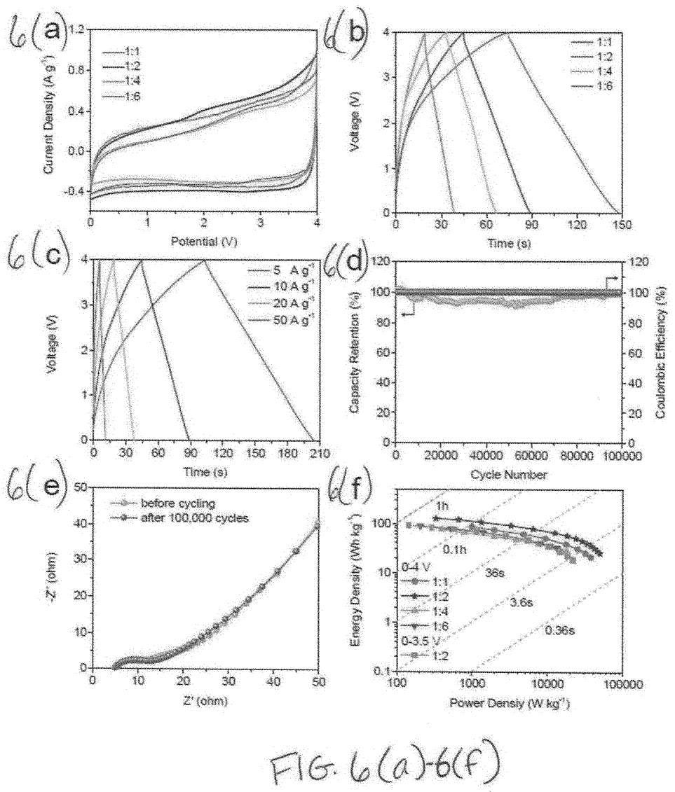

We employed SLC as both the cathode and anode in the lithium-ion capacitors. In order to obtain high energy of such hybrid device, the mass ratio of the electrodes required optimization. In the present work, the anode to cathode mass ratio is varied from 1:1 to 1:6, and the voltage range of lithium-ion capacitors is kept at 0-4.0 V and 0-3.5 V. As indicated in the previous section, when tested with a 4 V window, there is limited capacity decay after 10,000 cycles presumably due to some electrolyte decomposition on both electrodes. With a 3.5 V window, the capacity decay even after 100,000 cycles was negligible. The electrochemical performance of SLC//SLC LICs is shown in FIG. 6(a)-(f). FIG. 6a shows the CV curves at 10 mV s⁻¹ with different anode to cathode mass ratios. It can be seen that the shape of CV curves deviates from the ideal EDLC-like (also termed pseudocapacitor) rectangle shape owing to the combination non-EDLC storage mechanism described prior. FIG. 6b provides the galvanostatic charge-discharge profiles. These curves show symmetric quasi-triangular shape, which has been linked to fast charge behavior. However, the charge-discharge curves are not strictly linear, indicating the multiple charge storage mechanisms in the device, in accordance with the CV observation. With the increase of cathode to anode mass ratio, the charge-discharge curves of LIC gradually deviated from the ideal linear behavior, due to a high depth charge/discharge at the anode. FIG. 6c exhibits the galvanostatic charge-discharge profiles and CV curves of a LIC with an anode to cathode mass ratio of 1:2, at various current densities and scan rates, further confirming the superior fast rate capability.

The device cycling stability is key for practical applications and is a key performance parameter where HICs have consistently fallen behind conventional EDLC supercaps. The cycling performance of SLC based lithium-ion capacitor with an anode to cathode mass ratio of 1:2 is investigated at a current density of 50 A g⁻¹. When cycled between 0-3.5 V the device maintains 99% capacity retention after 100,000 cycles as well as 100% cycling Coulombic efficiency. These results are shown in FIG. 6d. The reason that the device cycling CE was 100% from the start was that the anodes we pre-conditioned prior to assembly, thereby accounting for the early CE loss. The preconditioning process consisted of 3 charge—discharge cycles in a half cell, prior to being disassembled and incorporated into a full cell. This was necessary for extended cycling, since no secondary source of Li beyond the LiPF₆ in the electrolyte was employed. Not employing a secondary source of Li (such as Li metal) in the device is extremely beneficial for extended cycling as it eliminates dendrite formation on the anode. This allows the reported 100,000 cycle lifetime without capacity or CE loss. Per the EIS analysis of the 3.5 V cycled samples (FIG. 6e), there is almost a negligible increase in system impedance. With a voltage window of 0-3.5 V, the values of Rₑ, R_{ct} and Z_{w} were barely changed after 100,000 cycles. Such stability has not been reported prior in literature and is attributed to the near “zero volume expansion” anode employed in the device.

Conventional graphite, ordered carbon, or multilayer graphene anodes intercalate Li ions during cycling. While this leads to a large anode capacity due to the bulk storage mechanism, it inevitably destroys the material due to the repeated expansion—contraction at every cycle. For lithium ion batteries, which need to survive several thousand cycles at most, this is (somewhat) acceptable. However, for a HIC device which needs compete with an ultracapacitor, repeated volumetric changes in the anode ultimately mean premature device failure. As herein, due to the highly disordered structure of SLC, minimum intercalation is expected. This is especially the case if one assumes a symmetric voltage swing on each electrode, i.e. 1.75 V anodic and 1.75 V cathodic. Conversely, reversible ion adsorption and Li underpotential deposition produce minimal volume changes in the anode, leading to the observed cycling stability.

When cycled at a higher voltage of 4.0 V, the DHIC device retained 82% capacity retention after 10,000 cycles. We attribute the significant difference in lifetime to a voltage—induced decomposition of the electrolyte on one or both of the electrodes. Once SEI/CEI growth is significant, once would expect that much of the Li ion active surface area becomes plugged by the carbonates and inorganic products. This is known failure mode of commercial EDLC supercapacitors, which exclusively rely on reversible ion adsorption on pure (undoped) carbon surfaces. Moreover, SEI formation by definition irreversibly consumes Li ions. This is problematic in architectures where the Li source is the dissolved salt in the electrolyte (e.g. 1 mol LiPF₆), such as the devices employed in this study.

FIG. 6f shows the Ragone plot of the SLC based lithium-ion capacitors, both with 4.0 and a 3.5 V window. The gravimetric power and energy density were obtained by calculating the total active materials in both electrodes at different current densities. The optimized lithium-ion capacitors can deliver a high energy of 127 W h kg⁻¹ at a power of 332 W kg⁻¹ (74 W h L⁻¹ at 193 W L⁻¹). At an extreme power of 33,573 W kg⁻¹ a solid energy of 40 W h kg⁻¹ is still achieved (23 W h L⁻¹ at 19,472 W L⁻¹). When tested at 0-3.5 V, the optimized LIC deliver 91 W h kg⁻¹ at 145 W kg⁻¹ (53 W h L⁻¹ at 84 W L⁻¹). These energy—power combinations are on par with prior published devices that were based on a bulk battery-type anode and a high surface area adsorption-type cathode. However, the symmetric 3.5 V SLC//SLC LIC is far superior in terms of cyclability. The battery-anode type architectures will at most survive 10,000 cycles, even when a narrower voltage window (Vₘₐₓ-Vₘᵢₙ) was employed. In fact, all but one of the voltage windows provided are 3 V or less, and yet with limited cyclability nonetheless. Conversely, the 3.5 V SLC//SLC LIC is unaffected by 100,000 full charge discharges.

It is instructive to consider the rate performance of this HIC relative to established metrics for EDLC supercapacitors, which are designed to charge in minutes or even seconds. This is quite far from the much higher energy lithium ion batteries, which are designed to charge in hours. The optimized (1:2 anode to cathode mass ratio) SLC//SLC device will maintain 114 W h kg⁻¹ when charged at 6 minutes, 75 W h kg⁻¹ when charged in 36 seconds, 36 W h kg⁻¹ when charged at 3.6 seconds. Due to the commercial packaged energy devices usually contain about 30-40 wt. % of active material, a factor of 3 is generally used to extrapolate the energy or power of the hybrid devices that based on the performance of the active material. Assuming this factor of 3 conversion from electrode to device weight, the resultant device energies are approximately 38, 25, and 12 W h kg⁻¹, respectively. These numbers would be 25, 16, and 7 W h kg⁻¹, if the 3.5 V device was considered instead. It may therefore be observed that at every relevant charging rate, the SLC//SLC LIC is superior to the 4-6 W h kg⁻¹ commercial supercapacitor, such as the publicly available Maxwell™ or Ioxus™ offerings.

Although the invention has been described with reference to a particular arrangement of parts, features and the like, these are not intended to exhaust all possible arrangements or features, and indeed, many modifications and variations will be ascertainable to those of skill in the art and are encompassed in the present invention.

What is claimed is:

1. A double hybridized ion capacitor comprising:
a high surface area carbon-containing positive electrode; and
a high surface area carbon-containing negative electrode,
wherein the high surface area carbon of the positive electrode is identical to the high surface area carbon of the negative electrode.

2. The double hybridized ion capacitor according to claim 1, wherein the high surface area carbon is a sulfurized carbon.

3. The double hybridized ion capacitor according to claim 2, wherein the negative electrode has a reversible capacity of 1186 mA h g⁻¹.

4. The double hybridized ion capacitor according to claim 1, wherein the high surface area carbon is heteroatom doped.

5. The double hybridized ion capacitor according to claim 1, further comprising an electrolyte.

6. The double hybridized ion capacitor according to claim 5, wherein the electrolyte comprises a solvent and LiPF₆.

7. The double hybridized ion capacitor according to claim 6, wherein a separate source of Li is not provided.

8. The double hybridized ion capacitor according to claim 1, wherein a precursor of the high surface area carbon comprises gulfweed.

9. The double hybridized ion capacitor according to claim 1, wherein a mass ratio of the positive electrode to the negative electrode is between 1:1 to 1:6.

10. The double hybridized ion capacitor according to claim 9, wherein the mass ratio of positive electrode to the negative electrode is 1:2.

11. The double hybridized ion capacitor according to claim 1, wherein the double hybridized ion capacitor delivers 127 W h kg⁻¹ at 332 W kg⁻¹.

12. The double hybridized ion capacitor according to claim 11, wherein the double hybridized ion capacitor delivers 40 W h kg⁻¹ at 33,573 W kg⁻¹

13. The double hybridized ion capacitor according to claim 1 having 99% capacity retention ratio after 100,000 cycles at 0-3.5V.

14. The double hybridized ion capacitor according to claim 1, wherein the positive electrode further comprises a lithium or sodium cathode,
wherein the lithium or sodium cathode is selected from iron phosphate (LFP, NFP) cathode, nickel cobalt aluminum (NCA) cathode, a nickel manganese cobalt (NMC) cathode, lithium or sodium cobalt oxide (LCO, NCO) cathode, Prussian blue analogs (PBAs), sodium vanadium phosphate and its alloyed modifications, vanadium fluorophosphate (NaVPO₄F) and its alloyed modifications, Na₂FeP₂O₇, Na₂MnP₂O₇, sodium vanadium oxide and its alloyed modifications, pure and doped sodium manganese oxide, sodium magnesium manganese oxide, layered oxides, Na₂V₂O₅ and its alloyed modifications, iron-based mixed-polyanion compounds LiₓNa₄₋ₓFe₃(PO₄)₂(P₂O₇) (x=0-3), NaxMO₂ where M is one or a combination of several transition metals, NASICON structures, NaNbFe(PO₄)₃, Na₂TiFe(PO₄)₃ and Na₂TiCr(PO₄)₃, NaFe_{0:5}Mn_{0:5}PO₄, NaVPO₄F, Na₃V₂(PO₄)₂F₃, and Na_{1:5}VOPO₄F_{0:5}, Na₂FeP₂O₇, Na_{0.67}Ni_{0.3}-xCuₓMn_{0.7}O₂, layered sodium transition metal oxides (NaₓTMO₂), Na_{0.76}Mn_{0.5}Ni_{0.3}Fe_{0.1}Mg_{0.1}O₂, O3-type NaNi_{1/4}Na_{1/6}Mn_{2/12}Ti_{4/12}Sn_{1/12}O₂ oxide, and NaₐNi_{(1-x-y-z)}MnₓMg_{y}Ti_{z}O₂, Na₂MnFe(CN)_{6.}

15. A double hybridized ion capacitor comprising:
a positive electrode; and
a negative electrode,
wherein the positive electrode comprises high surface area carbon derived from gulfweed and the negative electrode comprises high surface area carbon derived from gulfweed.

16. The double hybridized ion capacitor according to claim 15, wherein the double hybridized ion capacitor delivers 127 W h kg⁻¹ at 332 W kg⁻¹.

17. The double hybridized ion capacitor according to claim 16, wherein the double hybridized ion capacitor delivers 40 W h kg⁻¹ at 33,573 W kg⁻¹

18. The double hybridized ion capacitor according to claim 15 having 99% capacity retention ratio after 100,000 cycles at 0-3.5V.

19. A method for manufacturing a high surface area carbon, the method comprising:
combining gulfweed with potassium hydroxide (KOH) and drying the combined gulfweed and KOH to form a precursor comprising gulfweed; and
carbonizing the precursor at 900° C. to form a high surface area carbon, wherein the sponge like carbon comprises macropores, micropores and mesopores.

20. An electrode material comprising a high surface area carbon made according to a method of claim 19.
